(19) United States
(12) Patent Application Publication
(10) Pub. No.: US 2018/0286172 A1
(43) Pub. Date: Oct. 4, 2018

(54) Systems and Methods for Selecting Characters and Purchasing Tickets for Games of Chance

(71) Applicant: Waid Zein El-Dean, Edison, NJ (US)

(72) Inventor: Waid Zein El-Dean, Edison, NJ (US)

(21) Appl. No.: 15/471,975

(22) Filed: Mar. 28, 2017

(51) Int. Cl. G07F 17/32; G06K 19/04; G06Q 20/04; G06Q 50/34; G06K 19/06

(52) U.S. Cl. CPC G07F 17/329; G06K 19/041; G06Q 20/045; G07F 17/3223; G06K 19/06028; G07F 17/3209; G07F 17/3211; G06Q 50/34

(57) ABSTRACT

A method for selecting characters and purchasing tickets for at least one game of chance. The method prompts a user to select a game of chance. Then, databases are searched to determine a set of rules and characters available to be played. The user is presented with a first option to identify one or more identified characters from the set of characters available to be played and, if the user elects the option, one or more identified characters are received from the user. The user may also be presented with a second option to autogenerate one or more autogenerated characters and, if the user elects the option, one or more characters are autogenerated. The identified and autogenerated characters are verified to ensure they are consistent with the set of rules and displayed to the user via an electronic display. The user may purchase one or more tickets via the method.

### COPYRIGHT NOTICE

A portion of the disclosure of this patent document contains material which is or may be subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

Games of chance, such as lottery games, are well known. When participating in a typical lottery, a user purchases a lottery ticket from a vendor at a gas station, convenience store or other location. Many times, a particular lottery game requires the user to fill in selected lottery characters on a blank ticket, which is then scanned by the lottery vendor for generating a receipt. The receipt, which constitutes evidence of the selected characters, may be redeemed at a later time if and when he/she wins the lottery.

Such games of chance suffer from the disadvantage of requiring a user to prepare his/her lottery selections in advance by writing them on or transferring them to a blank lottery tickets. Many such users are also indecisive and spend much time within the sometimes small retail facilities in which such tickets are sold prior to making their final selections. Or, some such users are indecisive while waiting in line with other patrons behind them, thereby clogging the flow of traffic and/or space of the lottery ticket sales facility. This not only wastes paper, but is also time consuming and inconvenient for the user, the lottery vending facility, and other patrons thereof. There exists a need to eliminate this wasteful and often time consuming step when playing games of chance, such as lotteries.

### BRIEF SUMMARY OF THE INVENTION

Briefly stated, in one aspect of the present invention, a method for selecting characters for at least one game of chance is provided. The method includes the steps of: prompting the user to select a game of chance from the at least one game of chance; after the user selects the game of chance, searching at least one database to determine a set of available characters associated with the game of chance selected by the user; searching the at least one database to determine a set of rules associated with the game of chance selected by the user; presenting the user with a first option to identify one or more identified characters from the set of available characters; if the user elects the first option, receiving the one or more identified characters from the user; presenting the user with a second option to autogenerate one or more autogenerated characters from the set of available characters; if the user elects the second option, autogenerating the one or more autogenerated characters; verifying that a combination of the identified and autogenerated characters is consistent with the set of rules; and displaying the identified and autogenerated characters to the user via an electronic display.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 depicts an animated lottery blower (or air-mix machine) in accordance with one embodiment of the present invention;

FIG. 2 depicts a schematic view of an exemplary network environment within which various embodiments of the present invention may be implemented;

FIG. 3 depicts a block diagram of an exemplary computing device within which various embodiments of the present invention may be implemented;

FIGS. 4a and 4b depict a flowchart of steps of a process for selecting characters and purchasing tickets for a game of chance, in accordance with one embodiment of the present invention; and

FIG. 5 depicts an animated lottery ticket filled in with a user's selection of characters, in accordance with one embodiment of the present invention.

### DETAILED DESCRIPTION OF THE INVENTION

The subject application references certain processes which are presented as series of ordered steps. It should be understood that the steps described with respect to those processes are not to be understood as enumerated consecutive lists but could be performed in various orders while still embodying the invention described herein.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a number” may include a plurality of numbers. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

Various embodiments of the present invention provide methods, executable by an application or program resident on a computing system environment, to select characters for at least one game of chance. The application generally prompts a user to select a game of chance, after which various databases are searched for an available character set and rules associated with the game of chance. The user is then presented with options to identify one or more characters from the set of characters available to be played and/or have the application autogenerate them. The application also provides the user with the ability to manually change any of the selected and/or autogenerated characters. Characters acceptable to the user are displayed via an electronic screen using a graphic, such as the graphic of a virtual ticket filled in with appropriate characters. In some embodiments, the virtual ticket is provided with a barcode encoded with the user's approved characters. The barcode may be scanned by a lottery vendor to generate a physical lottery ticket or receipt for the user. Various embodiments also permit the user to purchase lottery tickets using a credit card or funded account and play at least one game of chance directly from the application.

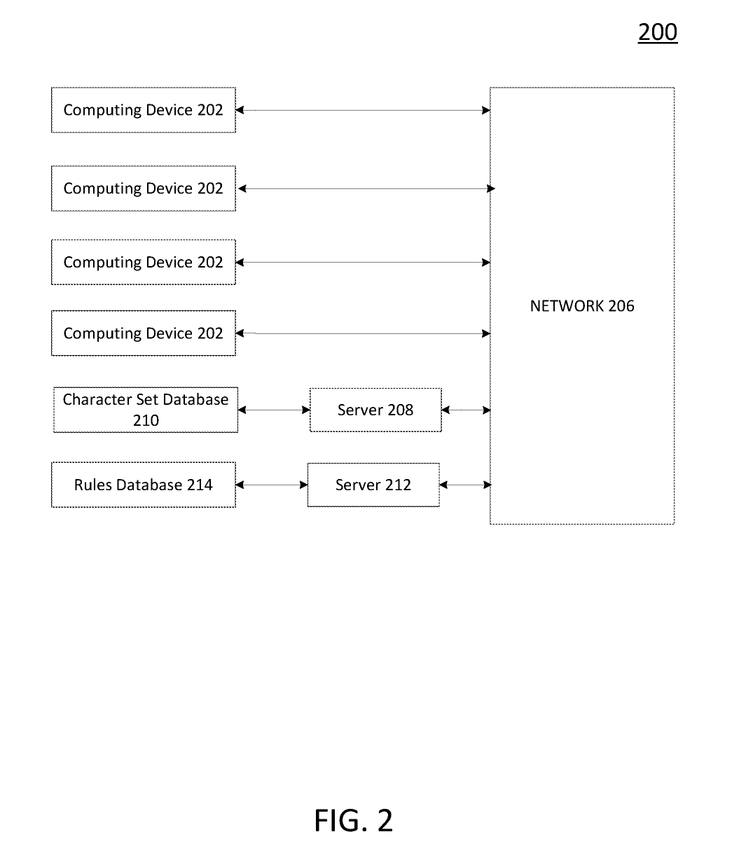

Referring now to FIG. 2, depicted is an exemplary computing system environment for allowing a user of system 200 to perform the methods described herein. The depicted computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (“PCs”), server computers, handheld or laptop devices, multi-processor systems, microprocessor-based systems, network PCs, minicomputers, mainframe computers, cell phones, tablets, embedded systems, distributed computing environments that include any of the above systems or devices, and the like.

Computer-executable instructions such as program modules executed by a computer may be used. Generally, program modules include routines, programs, objects, components, data structures, etc, that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

In the depicted embodiment, exemplary system 200 includes, inter alia, one or more computing devices 202 and one or more servers 208, 212 with corresponding databases, such as character set database 210 and rules database 214. The servers and databases shown in FIG. 2 are merely exemplary and servers and/or databases may be omitted or added without departing from the scope of the present invention. Further, databases 210, 214 may be combined into a single database and/or may be included in the respective servers without departing from the scope hereof. It should also be appreciated that one or more databases, including databases 210, 214 may be combined, provided in or distributed across one or more of computing devices 202, dispensing with the need for servers 208, 212 altogether.

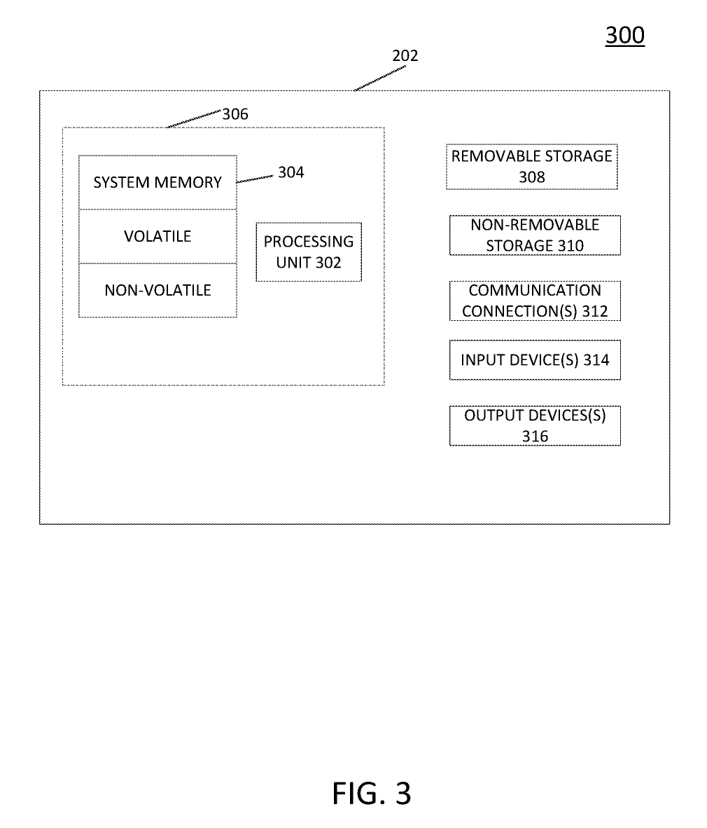

In its most basic configuration, as depicted in FIG. 3, computing device 202 includes at least one processing unit 302 and at least one memory 304. Depending on the exact configuration and type of the computing device, memory 304 may be volatile (such as random access memory (“RAM”)), non-volatile (such as read-only memory (“ROM”), flash memory, etc.), or some combination of the two. This most basic configuration is illustrated in FIG. 3 by dashed lines 306. In addition to that described herein, computing devices 202 can be any web-enabled handheld device (e.g., cell phone, smart phone, or the like) or personal computer including those operating via Android Apple®, and/or Windows® mobile or non-mobile operating systems.

Computing device 202 may have additional features/functionality. For example, computing device 202 may include additional storage (removable and/or non-removable) including, but not limited to, magnetic or optical disks or tape, thumb drives, and external hard drives as applicable. Such additional storage is illustrated in FIG. 3 by removable storage 308 and non-removable storage 310.

Computing device 202 typically includes or is provided with a variety of computer-readable media. Computer-readable media can be any available media that can be accessed by computing device 202 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 304, removable storage 308, and non-removable storage 310 are all examples of computer storage media. Computer storage media includes, but is not limited to, RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, or any other medium which can be used to store the desired information and which can accessed by computing device 202. Any such computer storage media may be part of computing device 202 as applicable.

Computing device 202 may also contain communications connection 312 that allows the device to communicate with other devices. Such communications connection 312 is an example of communication media. Communication media typically embodies computer-readable instructions, data structures, program modules and/or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (“RF”), infrared and other wireless media. The term computer-readable media as used herein includes both storage media and communication media.

Computing device 202 may also have input device(s) 314 such as keyboard, mouse, pen, voice input device, touch input device, etc. for receiving input from a user. Output device(s) 316 such as a display, speakers, printer, etc. may also be included. All these devices are generally known to the relevant public and therefore need not be discussed in any detail herein except as provided.

Notably, referring back to FIG. 2, computing device 202 may be one of a plurality of computing devices 202 inter-connected by network 206. As may be appreciated, network 206 may be any appropriate network and each computing device 202 may be connected thereto by way of connection 312 in any appropriate manner, and each computing device 202 may communicate with one or more of the other computing devices 202 via network 206 in any appropriate manner. For example, network 206 may be a wired network, wireless network, or a combination thereof within an organization or home or the like, and may include a direct or indirect coupling to an external network such as the Internet or the like. Likewise, network 206 may be such an external network including, without limitation, the Internet. In the exemplary embodiments shown herein, network 206 is the Internet and allows the multiple systems necessary to implement the systems and methods discussed herein to communicate data quickly and efficiently. However, alternate networks and/or methods of communicating information may be substituted without departing from the scope hereof.

Computing device 202 may connect to the various servers via such an internal or external network. Although FIG. 2 depicts computing device 202 located in close proximity to servers 208, 212, this depiction is not intended to define any geographic boundaries. For example, when network 206 is the Internet, computing device can have any physical location. For example, computing device may be a tablet, cell phone, personal computer, or the like located at any user's office, home, etc. Or computing device could be located proximate to one or more servers without departing from the scope hereof. Also, although FIG. 2 depicts computing devices 202 coupled to servers 208, 212 via network 206, computing devices may be coupled directly to one or more servers via any other compatible networks including, without limitation, an intranet, local area network, or the like.

The depicted embodiment of system 200 may use a standard client server technology architecture, which allows users of system 200 to access information stored in the databases via custom user interfaces. In some embodiments of the present invention, the processes are hosted on one or more servers which are accessible via the Internet using a publican)/addressable Uniform Resource Locator (“URL”). For example, users can access exemplary system 200 using any web-enabled device equipped with a web browser. Communication between software component and sub-systems are achieved by a combination of direct function calls, publish and subscribe mechanisms, stored procedures, and direct SQL queries, however, alternate components, methods, and/or sub-systems may be substituted without departing from the scope hereof. Also, alternate embodiments are envisioned in which a computing device 202 directly accesses one or more servers through a private network rather than via the Internet and a URL.

Computing devices 202 may be equipped with one or more Web browsers to allow them to interact with one or more servers and/or databases via a. HyperText Transfer Protocol (“HTTP”). HTTP functions as a request-response protocol in client-server computing. For example, a web browser operating on computing device 202 may execute a client application that allows it to interact with applications executed by the one or more servers. The client application submits HTTP request messages to the one or more servers. The corresponding servers, which provide resources such as HTML files and other data or content, or performs other functions on behalf of the client application, returns a response message to the client application upon request. The response typically contains completion status information about the request as well as the requested content. However, alternate methods of computing device/server communications may be substituted without departing from the scope hereof including those that do not utilize the Internet for communications.

In the exemplary system 200, the databases, such as character set database 210 and rules database 214, may include a plurality of databases and/or database tables. As may be appreciated, the databases may be any appropriate database capable of storing data and may be included within or connected to one or more servers similar to those described herein in any appropriate manner without departing from the scope hereof.

It should be understood that the various techniques described herein may be implemented in connection with hardware or software or, as appropriate, with a combination of both. Thus, the methods and apparatus of the presently disclosed subject matter, or certain aspects or portions thereof, may take the form of program code (i.e., instructions, scripts, and the like) embodied in tangible media, such as floppy diskettes, CD-ROMs, hard drives, flash drives, DVDs or any other machine-readable storage medium wherein, when the program code is loaded into and executed by a machine, such as a computer, the machine becomes an apparatus for practicing the presently disclosed subject matter.

In the case of program code execution on programmable computers, the interface unit generally includes a processor, a storage medium readable by the processor (including volatile and non-volatile memory and/or storage elements), at least one input device, and at least one output device. One or more programs may implement or utilize the processes described in connection with the presently disclosed subject matter (e.g., through the use of an application-program interface (“API”), reusable controls, or the like). Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as system 200 or a distributed computing environment. Still further, aspects of the presently disclosed subject matter may be implemented in or across a plurality of processing chips or devices, and storage may similarly be affected across a plurality of devices in system 200. Such devices might include personal computers, network servers, and handheld devices (e.g., cell phones, tablets, smartphones, etc.), for example.

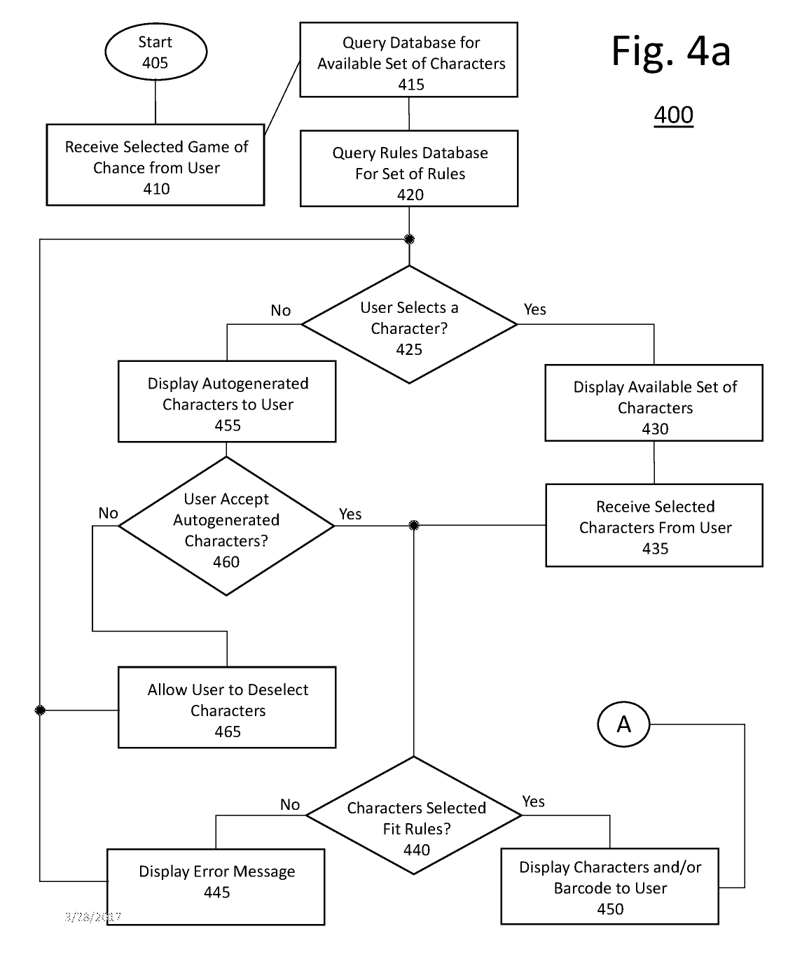

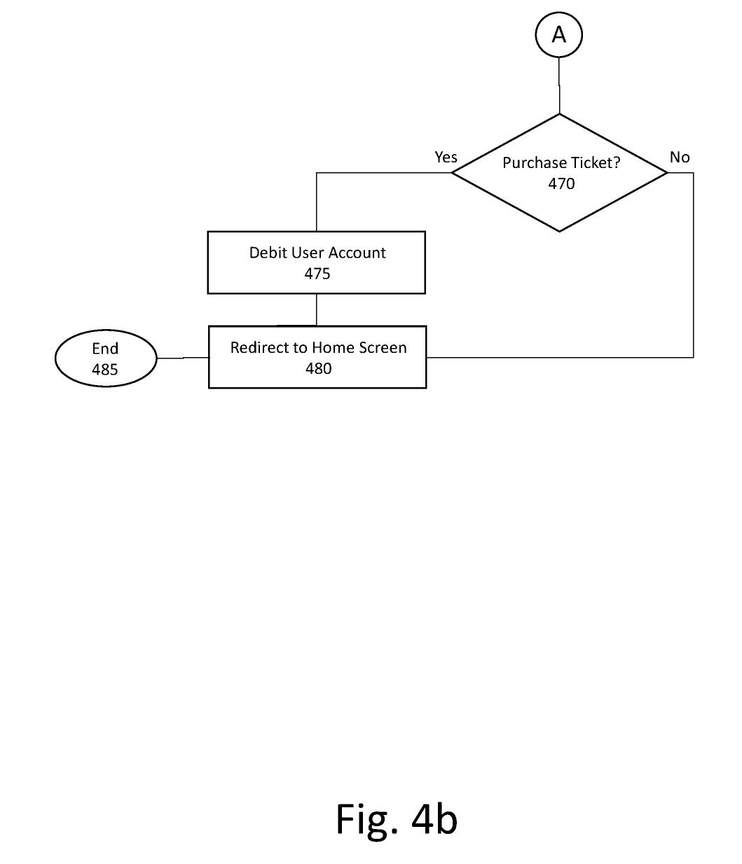

Referring now to FIGS. 4a and 4b, there is seen a flowchart of a process for selecting characters and purchasing tickets for a game of chance, in accordance with the present invention. The process may be implemented as a software application or other program to be executed, for example, on system 200 or a similar system. The process begins at step 405 and proceeds to step 410, at which the user is prompted via output device(s) 316 of a computing device 202 to select a game of chance from a group of available games of chance. Available games of chance may include, for example, lottery-type games of chance, in which the user selects a combination of characters from a set of characters available to be played with the game of chance. The user may also select other types of games, such as roulette, poker, Caribbean stud poker, three card poker baccarat, Let it Ride, craps, keno, black jack, slot machines, chess, checkers or other games of chance, such as those based on playing cards, dice, etc. It should be appreciated, however, that any and all types of games of chance may be made available to the user, and that various embodiments of the present invention are not intended to be limited to any particular type of game(s). Once the user decides on a game of chance to play, the user may select the game using a keyboard or other form of input device(s) 314.

After the user selects a game of chance to play, the process proceeds to step 415. At step 415, character set database 210 is queried for an available set of characters associated with the game of chance selected by the user. For example, in a game where the user may select six numbers from a set of numbers ranging from one to fifty, a query of the database may return the set of numbers [1, 2, 3, . . . 50]. Or, with respect to another game of chance in which colors are selected, the query may return a set of available colors from which the user may choose. To the extent a game of chance includes two characteristics from which the user may make a selection, such as colors and numbers, the query may return an available of set of colors and numbers from which the user may choose. Regardless, it should be appreciated that any type of characters or characteristics may be included within character set database 210, and that various embodiments of the present invention are not intended to be limited to any particular type of character or characteristic.

After database 210 is queried for an available set of characters, the process proceeds to step 420, at which the same or a different database, such as rules database 214, is queried for a set of rules associated with the game of chance selected by the user. The set of rules includes constraints and other requirements which may be placed on the user's selection of characters from the available set of characters returned from character set database 210. For example, in a game which requires the selection of six numbers from a set of numbers ranging from one to fifty, the set of rules may include a requirement that the user select no more and no less than six numbers. The rules may also include other constraints and/or requirements, such as a requirement forbidding the user from selecting the same number more than once or more than a certain number of times. The rules may also operate to ensure that the user selects numbers within an available range of numbers. For example, in the game described above requiring the selection of numbers from a set ranging from one to fifty, the set of rules may prevent the user from selecting numbers greater than fifty or less than one. Of course, it should be appreciated that any number and type of rules may be associated with the selected game of chance and included within rules database 214, and that various embodiments of the present invention are not intended to be limited to any type or number of rules.

After character set database 210 and rules database 214 are queried for an available set of characters and rules, the process proceeds to step 425. At this step, the user is presented with an option to select one or more characters and/or characteristics from the available set of characters/characteristics in accordance with the rules of the game of chance selected by the user in step 410. If the user elects to select one or more characters and/or characteristics, the set of available characters/characteristics is presented to the user in step 430. The characters and/or characteristics selected by the user are then received by the application at step 435, for example, via input device(s) 314, such as a keyboard or other suitable input device.

If the user does not elect to select one or more characters at step 425, the process proceeds to step 455. At this step, the application autogenerates the characters in accordance with the set of rules retrieved from rules database 214. After the characters are autogenerated, they are presented to the user for approval at step 460. If the user does not approve of one or more of the autogenerated characters, the process proceeds to step 465, at which the user is given the option to deselect any of the autogenerated characters. After the user deselects the unapproved characters, the process proceeds back to step 425, at which the user may manually select characters to replace the characters deselected at step 465 or may have one or more characters autogenerated again such that new characters are chosen by process 400.

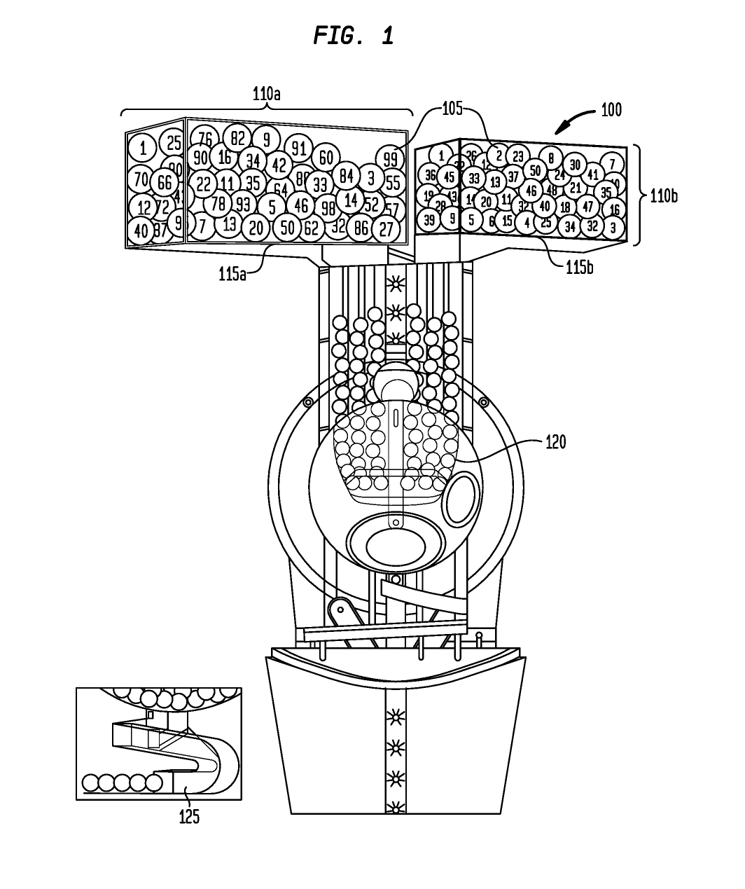

In one embodiment, output device(s) 316, such as an electronic display included within computing device 202, present the user with a graphic associated with the game of chance selected by the user at step 410. For example, in the event that the user selects a lottery-based game of chance, an animated lottery blower (or air-mix machine) 100, such as the one depicted in FIG. 1, may be presented. Lottery blower 100 includes one or more objects 105 associated with each of the available set of characters and/or characteristics available in the game of chance selected by the user. Objects 105 are organized into groups in accordance with at least one characteristic of objects 105, such as number and/or color. For example, in the embodiment depicted in FIG. 1, objects 105 are associated with respective numbers (1 to 99 or 1 to 50) and organized into two groups 110a, 110b based on the color of objects 105 (white or grey). Group 110a, 110b of objects 105 are positioned within respective chambers 115a, 115b having transparent side walls, and then released into a virtual central chamber 120, where they are blown around at random. As the user selects a character and color at step 435 or autogenerates them at step 455, animated lottery blower 100 causes an object 105 associated with the character and color to be dispensed via dispenser 125. For example, if the user selects or autogenerates “white” and “55”, animated lottery blower 100 causes a white object 105 having the number “55” imprinted thereon to be dispensed. In this manner, the application provides an exciting and dynamic manner by which the user's selected or autogenerated characters and/or characteristics may be received and displayed to the user in real time as the characters and/or characteristics are selected or autogenerated.

Referring back to FIG. 4a, after selected characters are received from the user at step 435 or autogenerated and approved by the user at step 460, the process proceeds to step 440, at which the application or other program compares the selected and/or autogenerated characters to the set of rules associated with the game of chance selected by the user. For example, if the rules require that a certain number of characters be selected, the application may compare the required number to the number of characters selected by the user and/or autogenerated. The application may also check that other constraints and requirements are met by the selected and/or autogenerated characters. If the characters and/or characteristics violate the set of rules associated with the game of chance selected by the user, an error message is displayed to the user at step 445, and the process proceeds back to step 425, at which the user is presented again with the option to select one or more characters and/or characteristics from the available set. If, on the other hand, the characters and/or characteristics are consistent with the set of rules, the process proceeds to step 450, at which the characters and/or characteristics are displayed to the user.

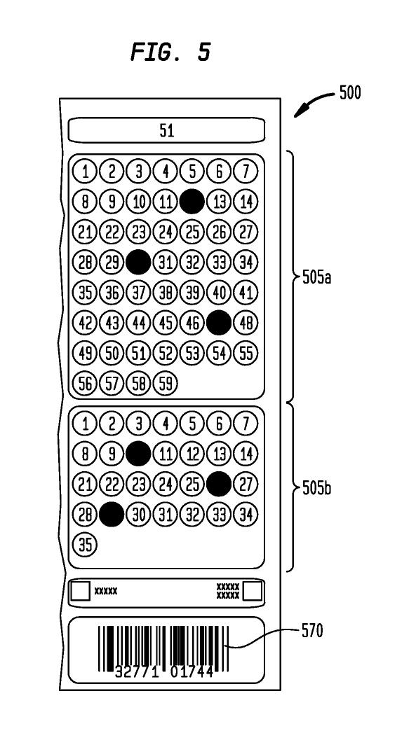

The characters and/or characteristics may be displayed to the user in any suitable manner including, without limitation, via dispenser 125 of lottery blower 100 or via a graphical representation, such as a graphical representation of a ticket. Referring now to FIG. 5, there is seen a graphical representation of a ticket 500 in accordance with the present invention. Ticket 500 includes one or more groupings of characters 505a, 505b, which may be associated with groups 110a, 110b of characters 105 depicted in animated lottery blower 100 of FIG. 1. The characters and/or characteristics selected by the user and/or autogenerated by the application are shown filled in on ticket 500, thereby providing a graphical representation of an actual ticket filled in with the appropriate characters and characteristics (in the example shown in FIG. 5, numbers “12”, “30”, and “47” from group 505a and numbers “10”, “26” and “29” from group 505b are shown filled in). The graphical representation of ticket 400 may also be provided with one or more barcodes, such as barcode 510, representing the characters and/or characteristics selected by the user and/or autogenerated by the application. In one embodiment, barcode 510 may be presented to a lottery vendor, which may then scan barcode 510 to generate a physical lottery ticket or receipt associated with the user's selections and/or to electronically receive the user's selections. In this manner, the user may provide a vendor with his/her lottery selections without the need to prepare and present a physical ticket. Barcode 510 may also be encoded with the user's character selections for numerous games of chance, thereby allowing the vendor to generate multiple tickets or receipts from a single scan.

With respect to at least some embodiments of the present invention, the user may also be provided with an additional option to play the selected game of chance directly via the application without the need to present the selected characters to a lottery vendor. In this embodiment, the process of FIGS. 4a and 4b proceeds from step 450 to step 470 (FIG. 4b), at which the user is presented with an option to purchase a lottery ticket in accordance with the characters selected by the user, such as, for example, using a credit card or any other suitable means of payment. Alternatively, the user may set up and fund an account with a desired amount of funds to be used for lottery purchases, and such account may be provided and/or maintained, for example, by the provider of the application. If the user opts not to purchase a ticket, the user is redirected to a home screen at step 480 and the process ends at step 485. On the other hand, if the user opts to purchase a ticket at step 475, the user is charged for the ticket (e.g., a credit card, PayPal, user account, or the like is debited in an amount equal to the purchase price of the ticket). The user is then redirected to the home screen at step 480. In the event the user wins the lottery or a portion thereof, winnings may be provided directly to the user, e.g., via a check, credit to the user's account, or via any other suitable means. Process 400 may also provide the user with an ability to view and/or withdraw his/her funds from the account at any time.

Although several processes have been disclosed herein as software, it may be appreciated by one of skill in the art that the same processes, functions, etc. may be performed via hardware or a combination of hardware and software. Similarly, although the present invention has been depicted as a hardwired system, these concepts may be applied to wireless systems and hybrid hardwired and wireless systems without departing from the scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A method for selecting characters for at least one game of chance comprising the steps of:
prompting the user to select a game of chance from the at least one game of chance;
after the user selects the game of chance, searching at least one database to determine a set of available characters associated with the game of chance selected by the user;
searching the at least one database to determine a set of rules associated with the game of chance selected by the user;
presenting the user with a first option to identify one or more identified characters from the set of available characters;
if the user elects the first option, receiving the one or more identified characters from the user;
presenting the user with a second option to autogenerate one or more autogenerated characters from the set of available characters;
if the user elects the second option, autogenerating the one or more autogenerated characters;
verifying that a combination of the identified and autogenerated characters is consistent with the set of rules; and
displaying the identified and autogenerated characters to the user via an electronic display.

2. A method according to claim 1, wherein the rules require that the combination of the identified and autogenerated characters includes a preselected number of characters, a number of the autogenerated characters being equal to a number of the preselected number of characters not identified by the user.

3. A method according to claim 1 further comprising the step of:
generating an error message if a number of characters in the combination of the identified and autogenerated characters is less than a preselected number of characters required by the set of rules.

4. A method according to claim 1 further comprising:
displaying a virtual air-mix machine to the user, the air-mix machine retaining at least one set of objects, each of the objects displaying one of the available characters associated with the game of chance selected by the user.

5. A method according to claim 4, wherein the objects are organized into a plurality of groups in accordance with at least one characteristic of the objects.

6. A method according to claim 5, wherein the at least one characteristic includes color.

7. A method according to claim 5, wherein each of the groups of objects is contained within a respective chamber having at least partially transparent walls through which the user may view the objects.

8. A method according to claim 1, wherein the step of displaying the identified and autogenerated characters to the user includes displaying the identified and autogenerated characters on a simulated ticket associated with the game of chance selected by the user.

9. A method according to claim 1, wherein the step of displaying the identified and autogenerated characters to the user includes displaying a barcode associated with the combination of the identified and autogenerated characters.

10. A method according to claim 1 further comprising the steps of:
presenting the user with a third option to reject one or more characters in the combination of the identified and autogenerated characters; and
if the user elects the third option, removing the characters rejected by the user and again presenting the user with the first and second options.

11. A method according to claim 1, wherein the game of chance selected by the user is operated by a provider of the method.

12. A method according to claim 1, further comprising the step of:
providing a financial account for the user.

13. A method according to claim 12, wherein the financial account of the user may be utilized for at least one of the group consisting of: debiting the financial account for a ticket purchase, crediting the financial account with game of chance winnings; and combinations thereof.

14. A method according to claim 1 further comprising the step of:
providing the user with an option to play one or more supplemental games.

15. A method according to claim 14 further comprising the steps of:
providing the user with an option to place a bet on the one or more supplemental games; and
if the user wins the one or more supplemental games, providing the user with a winning amount of money in accordance with the bet.
